(19) United States
(12) Patent Application Publication
(10) Pub. No.: US 2021/0141980 A1
(43) Pub. Date: May 13, 2021

(54) METHOD AND SYSTEM FOR REAL-TIME SIMULATIONS USING CONVERGENCE STOPPING CRITERION

(71) Applicant: ANSYS, INC., Canonsburg, PA (US)

(72) Inventors: Raunak Deepak Borker, Canonsburg, PA (US); Alex Main, Canonsburg, PA (US)

(21) Appl. No.: 16/705,921

(22) Filed: Dec. 6, 2019

Related U.S. Application Data
(60) Provisional application No. 62/933,213, filed on Nov. 8, 2019.

(51) Int. Cl. G06F 30/23

(52) U.S. Cl. CPC G06F 30/23; G06F 2111/10

(57) ABSTRACT

System and method is disclosed for a real-time simulation of a physical system using an iterative solver, such as a finite element solver, or other solvers having a mesh size independent stopping criterion. The method includes: calculating a potential solution for a set of equations used to simulate a characteristic for a model modeling a physical system; determining a difference between the potential solution and a previously calculated potential solution; determining if a stop condition is satisfied based on the difference, where the calculation is performed iteratively until the stop condition is satisfied; and generating an output to indicate the potential solution as a steady state solution or a stall solution for the simulated characteristic of the physical system according to the determining if the stop condition is satisfied.

### CROSS-REFERENCE TO RELATED APPLICATIONS

This application claims the benefit of U.S. Provisional Patent Application No. 62/933,213, filed Nov. 8, 2019, which is incorporated by reference herein in its entirety.

### BACKGROUND

The demand for simulation of physical systems of all types continues to grow, especially in areas of product development and design. Because physical production of prototypes for testing is time-consuming and often expensive, simulation, particularly simulation performed by computer systems, can provide a valuable tool that streamlines research and development to a narrow set of possible solutions to a problem prior to expensive physical testing.

The simulation of physical systems often employs a mesh which is used in a discretization method (e.g. finite volume method) to provide outputs for the simulation. A mesh includes elements that are typically simple shapes such as tetrahedrons, hexahedrons, prisms, and other volumetric (three dimensional—3D) shapes. These simple shapes have faces, edges, and vertices. A mesh includes a collection of these elements, which can be referred to as mesh elements, and a mathematical description of the relationship between the nodes, edges, and faces of the mesh elements. In a numerical analysis of physical systems, complicated three-dimensional shapes may be broken down to (i.e., approximated by) a mesh representation. The mesh representation may subsequently be used in setting up and solving equations for analysis using a discretization method (e.g. finite volume analysis) which may include numerical solution of partial differential equations based on boundary conditions. Other analysis methods can be used in other examples. Mesh-based analysis techniques are used widely in the fields of computational fluid dynamics (CFD), aerodynamics, electromagnetic fields, civil engineering, chemical engineering, naval architecture and other fields of engineering as well as manufacturing and fabrication processes, such as additive manufacturing processes.

### SUMMARY

System and method are provided for a real-time simulation of a physical system using an iterative solver, such as a finite volume solver, or other solvers having a convergence stopping criterion. The method includes: calculating a potential solution for a set of equations used to simulate a characteristic for a model modeling a physical system; determining a difference between the potential solution and a previously calculated potential solution; determining if a stop condition is satisfied based on the difference, where the calculation is performed iteratively until the stop condition is satisfied; and generating an output to indicate the potential solution as a steady state solution or a stall solution for the simulated characteristic of the physical system according to the determining if the stop condition is satisfied.

The aspects and embodiments described herein can include non-transitory machine readable media that store executable computer program instructions that when executed can cause one or more data processing systems to perform the methods described herein when the computer program instructions are executed by the one or more data processing systems. The instructions can be stored in nonvolatile memory such as flash memory or dynamic random access memory which is volatile or other forms of memory.

The above summary does not include an exhaustive list of all embodiments in this disclosure. All systems and methods can be practiced from all suitable combinations of the various aspects and embodiments summarized above, and also those disclosed in the Detailed Description below.

### BRIEF DESCRIPTION OF THE DRAWINGS

The present disclosure is illustrated by way of example and not limitation in the figures of the accompanying drawings, in which like references indicate similar elements and in which:

FIG. 1 is a block diagram illustrating a networked system according to one embodiment.

FIG. 2 is a block diagram illustrating an example of a simulation.

FIG. 3A is a block diagram illustrating an example of a real-time simulation environment according to one embodiment.

FIG. 3B is a block diagram illustrating an example of a solver module according to one embodiment.

FIG. 4 is a flowchart which illustrates a particular simulation method according to one embodiment.

FIGS. 5A-5B show an example of an aerodynamic simulation for a physical system according to one embodiment.

FIGS. 6A-6C show the simulation results for various mesh sizes according to some embodiments.

FIG. 7 is a flow diagram for a method according to one embodiment.

FIGS. 8A-8C depict example systems for use in implementing a system according to one embodiment.

### DETAILED DESCRIPTION

FIG. 1 depicts at 100 a computer-implemented environment wherein users 102 can interact with a system 104 hosted on one or more servers 106 through a network 108. The system 104 contains software operations or routines. The users 102 can interact with the system 104 through a number of ways, such as over one or more networks 108. One or more servers 106 accessible through the network(s) 108 can host system 104. It should be understood that the system 104 could also be provided on a stand-alone computer for access by a user. Note the system 104 can also be accessed through an application programmable interface (API).

FIG. 2 is a block diagram illustrating an example of a simulation. Referring to FIG. 2, system 200 is a simulation process which solves a system of equations to obtain an increment ΔUᵢ₋₁ to the potential solution (Uᵢ₋₁), e.g., F(U)=0, in an iterative process, where i is an index for an iteration, U is the potential solution, Δ is a difference value for two consecutive iterations, and F represents one or more equations characterizing a physical system. The system of equations is set up with one or more boundary conditions to simulate a characteristic of the physical system that is modeled by a number of mesh elements. The iterative process is stopped when a potential solution which satisfies a convergence condition is found, e.g., if the potential solution (Uᵢ=ΔUᵢ₋₁+Uᵢ₋₁) matches a target (true) solution (Uₒ). That is, F(ΔUᵢ₋₁+Uᵢ₋₁)=F(Uₒ)=0. The potential solution matching a target (true) solution can be inferred by computing the error eᵢ, where eᵢ=∥Uᵢ−Uₒ∥=0. Since the target solution Uₒ is not known during the iterative process, a simulator/solver cannot readily evaluate whether the solution Uᵢ is close to the target solution Uₒ.

A typical approach is to use a residual, r₁=F(Uᵢ), as an indicator of the error eᵢ or the closeness of the potential solution to a target solution. In practice, the iterative process is stopped when the residual is relatively small, that is,

$$\frac{‖ {r}_{i} ‖}{‖ {r}_{o} ‖} < ϵ ,$$

where ϵ is a convergence tolerance value, and rₒ is a residual value based on an initial guess of the solution.

However, a residual approach requires the convergence tolerance, ϵ, to be adjusted based on the value of rₒ, and the value of rₒ or a change of rₒ is dependent on a model of the physical system being simulated, e.g., rᵢ∝F(Uᵢ)∝mesh size, e.g., mesh size dependent. Thus, the stopping criterion (e.g., convergence tolerance) and/or a rate of convergence is dependent on a mesh size of the model. In other words, a finer mesh size for the same model would require a different E for convergence, which if E is chosen incorrectly the simulation system can have an increased computational load and an increased time to convergence. Here, mesh size refers to a size of a mesh element. A model can be made up of a number of mesh elements or cells. For example, a 3D model made up of 100×100×50 elements can have mesh size of (dx, dy, and dz) for the dimensions of a single cell in a xyz coordinate system.

Furthermore, reconfiguration of the inputs for the physical model or other input parameters can require additional manual adjustments for one or more simulation parameters (e.g., convergence tolerance, residual value) for the simulator/solver. Thus, the simulation has to be restarted after reconfiguration.

FIG. 3A is a block diagram illustrating an example of a real-time simulation environment according to one embodiment. Real-time simulation environment can simulate a 1D, 2D, or 3D physical systems for different characteristics, such as structural, fluid dynamics, electromagnetics, aerodynamics, etc., for the physical system. Referring to FIG. 3A, simulation environment 150 includes a mesh generator 156 and solver module 158. Mesh generator 156 can take a physical system model input 152, specify a size (e.g., a length of an edge of individual mesh elements), and generate a mesh model to represent the physical system. Solver module 158 can be any type of solver, such as a finite element solver, having a mesh-size independent stopping criterion. Solver module 158 can solve for a potential solution based on a set of equations, or physics 154, and a mesh model from mesh generator 156 generating solver results 160. Here the set of equations describe one or more characteristics being simulated. In one embodiment, the solver results 160 can be displayed in a user interface and a user can reconfigure the model or any other inputs in real-time based on the simulation feedbacks. Thus, simulation results can be reflected in real-time based on the reconfigurations.

FIG. 3B is a block diagram illustrating an example of a solver module according to one embodiment. Referring to FIG. 3B, solver module 158 includes potential solution calculation module 301, change determiner module 303, and stop condition determiner module 305. Potential solution calculation module 301 can calculate one or more potential solutions based on a set of equations. Change determiner module 303 can determine a delta (or change) in the potential solutions. Stop condition determiner module 305 can determine if a stop condition is satisfied to stop an iterator for solver module 158.

FIG. 4 is a flowchart which illustrates a particular simulation method according to one embodiment. Process 400 may be performed by processing logic which may include software, hardware, or a combination thereof. For example, process 400 can be performed by solver module 158 of FIGS. 3A-3B. Referring to FIG. 4, at block 401, processing logic performs a single iteration, of a series of iterations of operations to generate potential solutions with or without computing a target solution for a formulation to model a physical system.

To configure a simulation, a formulation (or a set of equations or an objective function) is applied to a model of the physical system. The formulation specifies the properties of the model and/or the types of simulations to simulate. These simulations can include simulations for structural, electromagnetics, fluid dynamics, aerodynamics, etc. The solver can iterate over a finite dimensional solution space to determine a potential solution for the formulation.

In one embodiment, a Jacobian (or Hessian) function,

$$J = \frac{\partial F}{\partial U} ,$$

is specified tor the objective function. Because the solver has information about the Jacobian (gradient information) at various points of the simulation, convergence can be achieved at a faster rate. In one embodiment, the iterative process is relaxed. In this case, the Jacobian,

$$J = \frac{\partial F}{\partial U}$$

is replaced with \tilde{J}=J+ω diag(J), where ω is a relaxation parameter applying a slope to the Jacobian. If the slope or the relaxation parameter is a large value, the iterations can generate potential solutions that overshoots which cause oscillations or a stall. However, applying a small slope relaxes the iterations, thus, improving a convergence for the simulation.

At block 403, processing logic determines a difference or an amount of change, ΔUᵢ₋₁=Uᵢ−Uᵢ₋₁, between the calculated solution and a solution of a previous iteration (e.g., a pair of solutions). At block 405, processing logic determines if the potential solutions or the amount of change between the pair of solutions produced by two consecutive iterations satisfies a stop condition. If the change in the solution is relatively small, the solution has either converged to an exact solution or the iterative process has stalled. E.g., the potential, Uᵢ, at the ith iteration has converge to a particular solution independent of a target (or true) solution, Uₒ.

In one embodiment, the stop condition includes a convergence criterion or a stall criterion. In one embodiment, the stop condition includes a condition that the potential solution converged to a target solution. In one embodiment, a convergence criterion includes the condition that a percentage change in the potential solution or a sum of absolute value of a percentage change in the potential solution is smaller than a predetermined threshold, e.g.,

$$\frac{{‖ Δ {U}_{i} ‖}_{1}}{{‖ {U}_{i} ‖}_{1}} < ϵ .$$

Here, the type of norm used is l-norm, e.g., a sum of absolute values. In one embodiment, ϵ is specified to be 0.01. In this case, the convergence condition is independent of F(U), or independent of a mesh size.

In one embodiment, a stall criterion includes the condition that the potential solution oscillates back and forth over a number of iterations. For example, a stall criterion can be detected to have occurred over a hundred iterations or any number of iterations based on some predetermined conditions. In one embodiment, the predetermined conditions include, computing a moving average for a change of the potential solution and/or a moving average for a change of the residual. The moving averaging help smooth the data by filtering out any noise. E.g., removing the one-off fluctuations. Then the moving averages over the last 100 iterations (or a history of past iterations) can be compared for consistencies. If the comparison for the consistency indicates the moving average has not change or gone up in the last number of iterations (e.g., 100 iterations) then it is determined the simulation have stalled. For example: for k=1, 2, . . . , N (where N is any number >2, such as 100)

if ∥ [symbol] ∥₁>∥ [symbol] ₁ and [symbol] >\tilde{r}ₗ, where ∥ [symbol] ₁=α∥ΔUᵢ∥₁+(1−α)∥ [symbol] ∥₁,

$$β \frac{{r}_{i}}{{r}_{max}} + ( 1 - β ) ,$$

where α is a moving average coefficient for the difference of potential solutions, β is a moving average coefficient for the residual, and the type of norm used is l-norm, e.g., a sum of absolute values. Both α and β can be preconfigured with default values or may be specified by a user. In one embodiment, α or β is specified to be 0.05.

In one embodiment, the stop condition includes a modified convergence criterion to maintain mesh independence for a solver that uses a modified relaxed Jacobian matrix, the modified convergence criterion can be:

$$\frac{{‖ Δ {U}_{i} ‖}_{*}}{{‖ {U}_{i} ‖}_{1}} < ϵ$$

where

$${‖ U ‖}_{*} = {\sum }_{i = 1}^{N} \frac{\vert {U}_{i} \vert}{ω {h}_{i}} ,$$

hᵢ is the size of mesh cell i, ω is the relaxation factor, and the type of norm used is l-norm, e.g., a sum of absolute values.

If a stop condition is satisfied, at block 407, processing logic stops the iterations and the simulation result outputs the potential solution at the stop condition. If the stop condition is a stall condition, the simulation result can output any of a number of solutions (an averaged value, a value from the last iteration, etc.) surrounding the stall condition. Otherwise processing logic continues to block 401.

FIGS. 5A-5B show an example of an aerodynamic simulation for a physical system according to one embodiment. Simulation 500 simulates the aerodynamic design of a truck. Here, the simulation problem has no steady state solution and a simulation based on a residual value would not result in convergence. However, simulating the aerodynamics of the truck using a real-time simulation environment 150 (having the mesh-size independent stop criterion) of FIG. 3A, can achieve a stop condition. The stop condition can result in a stall solution as the simulated aerodynamics surrounding a front under body portion of the truck oscillates back and forth, and the oscillation is detected as a stall condition.

FIGS. 6A-6C show the simulation results for various mesh sizes according to some embodiments. Simulation 600 simulates a fluid flow in an x direction of a flat surface having a bump at approximately x=2.5 meters. Referring to FIGS. 6A-6C, the respective mesh sizes are 320×64, 640×128, and 1280×256. Irrespective of the mesh size, the same tolerance of ϵ=0.01 gives the converged simulated flow pressure (Pa). Reducing the tolerance further doesn't change the solution noticeably further in any of the cases.

FIG. 7 is a flow diagram for a method according to one embodiment. Process 700 may be performed by processing logic which may include software, hardware, or a combination thereof. For example, process 700 can be performed by solver module 158 of FIGS. 3A-3B. Referring to FIG. 7, at block 701, processing logic calculates a potential solution for a set of equations to simulate a physical system. At block 702, processing logic determines a difference between the potential solution and a previously calculated potential solution. At block 703, processing logic determines if a stop condition is satisfied based on the difference, where the calculation is performed iteratively until the stop condition is satisfied. At block 704, processing logic generates an output to indicate the potential solution as a steady state solution or a stall condition for the simulated characteristic of the physical system according to the determining if the stop condition is satisfied.

In one embodiment, the stopping condition includes a convergence condition or a stall condition. In another embodiment, the convergence condition indicates the potential solution has converted to a particular solution independent of a target solution. In one embodiment, the calculation is performed iteratively using a relaxation method. In one embodiment, the physical system is modeled by generating one or more mesh to represent the physical system and a stopping criterion for the simulation is independent of a size of the generated mesh.

In one embodiment, the simulation of the physical system includes a simulation for structural analysis, fluid analysis, thermal analysis, or aerodynamics analysis and the simulation includes a steady state simulation solving for a steady state for the simulation. In one embodiment, the stop condition is independent of a residual of the solution.

The methods and systems described herein may be implemented using any suitable processing system with any suitable combination of hardware, software and/or firmware, such as described below with reference to the non-limiting examples of FIGS. 8A-8C.

FIGS. 8A-8C depict example systems for use in implementing a system. For example, FIG. 8A depicts an exemplary system 200 that includes a standalone computer architecture where a processing system 202 (e.g., one or more computer processors) includes a system 204 being executed on it. The processing system 202 has access to a non-transitory computer-readable memory 206 in addition to one or more data stores 208. The one or more data stores 208 may contain first data 210 as well as second data 212.

FIG. 8B depicts a system 220 that includes a client server architecture. One or more user PCs 222 accesses one or more servers 224 running a system 226 on a processing system 227 via one or more networks 228. The one or more servers 224 may access a non-transitory computer readable memory 230 as well as one or more data stores 232. The one or more data stores 232 may contain first data 234 as well as second data 236.

FIG. 8C shows a block diagram of exemplary hardware for a standalone computer architecture 250, such as the architecture depicted in FIG. 8A, that may be used to contain and/or implement the program instructions of system embodiments of the present invention. A bus 252 may serve as the information highway interconnecting the other illustrated components of the hardware. A processing system 254 labeled CPU (central processing unit) (e.g., one or more computer processors), may perform calculations and logic operations required to execute a program. A non-transitory computer-readable storage medium, such as read only memory (ROM) 256 and random access memory (RAM) 258, may be in communication with the processing system 254 and may contain one or more programming instructions. Optionally, program instructions may be stored on a non-transitory computer-readable storage medium such as a magnetic disk, optical disk, recordable memory device, flash memory, or other physical storage medium. Computer instructions may also be communicated via a communications signal, or a modulated carrier wave, e.g., such that the instructions may then be stored on a non-transitory computer-readable storage medium.

A disk controller 260 interfaces one or more optional disk drives to the system bus 252. These disk drives may be external or internal floppy disk drives such as 262, external or internal CD-ROM, CD-R, CD-RW or DVD drives such as 264, or external or internal hard drives 266. As indicated previously, these various disk drives and disk controllers are optional devices.

Each of the element managers, real-time data buffer, conveyors, file input processor, database index shared access memory loader, reference data buffer and data managers may include a software application stored in one or more of the disk drives connected to the disk controller 260, the ROM 256 and/or the RAM 258. Preferably, the processor 254 may access each component as required.

A display interface 268 may permit information from the bus 256 to be displayed on a display 270 in audio, graphic, or alphanumeric format. Communication with external devices may optionally occur using various communication ports 272.

In addition to the standard computer-type components, the hardware may also include data input devices, such as a keyboard 272, or other input device 274, such as a microphone, remote control, pointer, mouse, touchscreen and/or joystick.

This written description describes exemplary embodiments of the invention, but other variations fall within scope of the disclosure. For example, the systems and methods may include and utilize data signals conveyed via networks (e.g., local area network, wide area network, internet, combinations thereof, etc.), fiber optic medium, carrier waves, wireless networks, etc. for communication with one or more data processing devices. The data signals can carry any or all of the data disclosed herein that is provided to or from a device.

The methods and systems described herein may be implemented on many different types of processing devices by program code comprising program instructions that are executable by the device processing system. The software program instructions may include source code, object code, machine code, or any other stored data that is operable to cause a processing system to perform the methods and operations described herein. Any suitable computer languages may be used such as C, C++, Java, etc., as will be appreciated by those skilled in the art. Other implementations may also be used, however, such as firmware or even appropriately designed hardware configured to carry out the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other non-transitory computer-readable media for use by a computer program.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

It should be understood that as used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Finally, as used in the description herein and throughout the claims that follow, the meanings of “and” and “or” include both the conjunctive and disjunctive and may be used interchangeably unless the context expressly dictates otherwise; the phrase “exclusive or” may be used to indicate situation where only the disjunctive meaning may apply.

What is claimed is:

1. A computer-implemented method for simulating a physical system, the method comprising:
calculating a potential solution for a set of equations used to simulate a characteristic for a model modeling a physical system;
determine a difference between the potential solution and a previously calculated potential solution;
determining if a stop condition is satisfied based on the difference, wherein the calculation is performed iteratively until the stop condition is satisfied; and
generating an output to indicate the potential solution as a steady state solution or a stall solution for the simulated characteristic of the physical system according to the determining if the stop condition is satisfied.

2. The method of claim 1, wherein the stopping condition includes a convergence condition or a stall condition.

3. The method of claim 2, wherein the convergence condition indicates the potential solution has converted to a particular solution independent of a target solution.

4. The method of claim 1, wherein the calculation is performed iteratively using a relaxation method.

5. The method of claim 3, wherein the physical system is simulated by generating one or more mesh to represent the physical system and a stopping criterion for the simulation is independent of a size of the generated mesh.

6. The method of claim 1, wherein the simulation of the physical system includes a simulation for structural analysis, fluid analysis, thermal analysis, or aerodynamics analysis and the simulation includes a steady state simulation solving for a steady state for the simulation.

7. The method of claim 1, wherein the stop condition is independent of a residual of the solution.

8. A system, comprising:
a network interface for connecting to a network;
a memory storing instructions;
one or more processors coupled to the network interface and the memory, the one or more processors executing the instructions from the memory, the instructions including
calculating a potential solution for a set of equations used to simulate a characteristic for a model modeling a physical system;
determine a difference between the potential solution and a previously calculated potential solution;
determining a stop condition is satisfied based on the difference, wherein the calculation is performed iteratively until the stop condition is satisfied; and
generating an output to indicate the potential solution as a steady state solution or a stall condition for the simulated characteristic of the physical system according to the determining if the stop condition is satisfied.

9. The system of claim 8, wherein the stopping condition includes a convergence condition or a stall condition.

10. The system of claim 9, wherein the convergence condition indicates the potential solution has converted to a particular solution independent of a target solution.

11. The system of claim 8, wherein the calculation is performed iteratively using a relaxation method.

12. The system of claim 8, wherein the physical system is simulated by generating one or more mesh to represent the physical system and a stopping criterion for the simulation is independent of a size of the generated mesh.

13. The system of claim 8, wherein the simulation of the physical system includes a simulation for structural analysis, fluid analysis, thermal analysis, or aerodynamics analysis and the simulation includes a steady state simulation solving for a steady state for the simulation.

14. The system of claim 8, wherein the stop condition is independent of a residual of the solution.

15. A non-transitory computer-readable medium storing instructions for commanding one or more processors to perform a method, the method comprising:
calculating a potential solution for a set of equations used to simulate a characteristic for a model modeling a physical system;
determine a difference between the potential solution and a previously calculated potential solution;
determining a stop condition is satisfied based on the difference, wherein the calculation is performed iteratively until the stop condition is satisfied; and
generating an output to indicate the potential solution as a steady state solution or a stall solution for the simulated characteristic of the physical system according to the determining if the stop condition is satisfied.

16. The non-transitory computer-readable medium of claim 15, wherein the stopping condition includes a convergence condition or a stall condition.

17. The non-transitory computer-readable medium of claim 16, wherein the convergence condition indicates the potential solution has converted to a particular solution independent of a target solution.

18. The non-transitory computer-readable medium of claim 15, wherein the calculation is performed iteratively using a relaxation method.

19. The non-transitory computer-readable medium of claim 15, wherein the physical system is simulated by generating one or more mesh to represent the physical system and a stopping criterion for the simulation is independent of a size of the generated mesh.

20. The non-transitory computer-readable medium of claim 15, wherein the simulation of the physical system includes a simulation for structural analysis, fluid analysis, thermal analysis, or aerodynamics analysis and the simulation includes a steady state simulation solving for a steady state for the simulation.

21. The non-transitory computer-readable medium of claim 15, wherein the stop condition is independent of a residual of the solution.
